(19) United States
(12) Patent Application Publication
(10) Pub. No.: US 2008/0043747 A1
(43) Pub. Date: Feb. 21, 2008

(54) Apparatus, method, system and software product for a scheduling synchronization mechanism in a multi-hop environment

(76) Inventor: Haihong Zheng, Coppell, TX (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/890,276

(22) Filed: Aug. 3, 2007

Related U.S. Application Data
(60) Provisional application No. 60/835,786, filed on Aug. 4, 2006.

(51) Int. Cl. H04L 12/28

(52) U.S. Cl. 370/395.41

(57) ABSTRACT

A method is disclosed for commencing distributed scheduling of uplink communication, in a component of a multihop relay system of a wireless network. The component sends information that is related to the scheduling, to a direct downlink neighbor along a multihop path. This information at least indicates a time interval available for the uplink communication, that time interval corresponding to a hop of the path between the neighbor and the component. The time interval is shorter for a hop that is downstream from another hop which corresponds to a longer time interval.

### CROSS REFERENCE TO RELATED APPLICATION

Priority is claimed to U.S. Provisional Application No. 60/835,786 filed Aug. 4, 2006.

### BACKGROUND OF THE INVENTION

1. Technical Field

The present invention pertains to the field of telecommunications. More particularly, the present invention pertains to scheduling for data transmission.

2. Discussion of Related Art

Broadband wireless access (BWA) has become an attractive way to meet escalating business demand for rapid Internet connection and integrated data, voice and video services. One of the most compelling aspects of BWA technology is that networks can be created in just weeks by deploying a small number of base stations on buildings or poles to create high-capacity wireless access systems. BWA has had limited reach so far, in part because of the unmet need for a universal standard. While providing such a standard is important for developed countries, it is even more important for the developing world where wired infrastructures are limited.

The Institute of Electrical and Electronics Engineers Standards Association (IEEE-SA) sought to make BWA more widely available by developing IEEE Standard 802.16, which specifies the WirelessMAN Air Interface for wireless metropolitan area networks. This standard was created in a two-year, open-consensus process by hundreds of engineers from the world's leading operators and vendors.

Applicant hereby incorporates by reference IEEE Standard for Local and Metropolitan Area Networks, IEEE Std. 802.16-2004, Sections 6.3.5-6.3.6 as amended by IEEE Standard for Local and Metropolitan Area Networks Std. 802.16e-2005. IEEE 802.16-2004 enables rapid worldwide deployment of innovative, cost-effective, and interoperable multivendor broadband wireless access products, facilitates competition in broadband access by providing alternatives to wireline broadband access, encourages consistent worldwide spectrum allocations, and accelerates the commercialization of broadband wireless access systems. IEEE 802.16e-2005 provides enhancements to IEEE 802.16-2004 to support subscriber stations moving at vehicular speeds, and thereby specifies a system for combined fixed and mobile broadband wireless access.

The introduction of relay stations into metropolitan area networks allows providing ubiquitous broadband access economically to everyone, even to subscribers in remote places. IEEE 802.16, also sometimes known as WiMAX, is one of the most promising technologies for multihop communication. Such a relay enhanced IEEE 802.16 network will be able to provide ubiquitous radio coverage, achieve high quality of service (QoS) requirements, and it can be economically deployed and operated.

As a person skilled in the art will understand, an example of a single hop system is a microwave system between one building (e.g. in downtown San Francisco) and another building across town (e.g. in uptown San Francisco). Each of these two buildings has its own microwave antenna on its roof. Now suppose that we want to expand this system to Oakland. We would put a second antenna on the uptown San Francisco building, and then shoot across to an antenna in Oakland. That building in San Francisco would now have a “multi-hop” transmission system which can act as a relay for traffic between the Oakland and downtown San Francisco building.

IEEE 802.16's Mobile Multihop Relay Study Group was chartered on 22 Jul. 2005. The Study Group expired on 30 Mar. 2006, with the approval of its Project Authorization Request (PAR), and development of that project has been assigned to IEEE 802.16's Relay Task Group.

In a multihop environment such as IEEE 802.16 mobile multihop relay (MR) networks, the scheduling between multiple hops (e.g., BS and relay stations) on a path should be synchronized to avoid excessive delay and bandwidth waste. The present invention discloses a simple and efficient solution to this scheduling synchronization issue.

In a network system, in order to transmit data based on a requirement such as quality of service (QoS), data needs to be scheduled by the source node and each intermediate node on the path to the destination. Scheduling services represent the data handling mechanism supported by the scheduler for data transport.

As explained in IEEE Std. 802.16-2004 (section 6.3.5.2), uplink request/grant scheduling is typically performed by the BS with the intent of providing each direct downlink neighbor, i.e. each subordinate mobile station (MS) or subscriber station (SS), with bandwidth for uplink transmissions, or opportunities to request bandwidth (also called polls). Ideally, by specifying a scheduling service and its associated QoS parameters, the BS scheduler can anticipate the throughput and latency needs of the uplink traffic, and provide polls and/or grants at the appropriate times.

The existing scheduling mechanism works fine in the single hop environment where mobile stations are attached to the base station or access point directly. However, when the multi-hop concept is introduced in a wireless environment, issues related to scheduling synchronization are raised. Two types of multi-hop environments are now described: a wireless mesh network and a wireless relay network.

In a Wireless Mesh network, a multi-hop system has nodes (e.g. called mesh nodes) which connect to each other via wireless media—such as wireless local area network (WLAN) or WiMax—and assist each other in transferring traffic in the network. A mesh node can send and receive traffic and also acts as a router and relay traffic for its neighbors. Both IEEE 802.11 and IEEE 802.16 support mesh mode in the standard. Communication in the mesh network should be controlled by a centralized algorithm or in a distributed manner. With a centralized scheduling, the base station (BS) determines the resource assignment and ensures that transmissions are coordinated to ensure collision-free scheduling. With a distributed scheduling, each mesh node performs independent scheduling with coordination with their extended neighbor and without relying on the BS.

In a Wireless Relay network, a multi-hop system has end nodes (Mobile Stations/Subscriber Stations) which are connected to the base station (BS) or access point (AP) via a Relay Station (RS). All the traffic between Mobile Stations/Subscriber Stations (MS/SSs) and BS/AP passes and is processed by the RS. An example of relay concept is the 802.16 Mobile Multi-hop Relay (MMR). The MMR work focuses on defining a network system that uses Relay Stations (RSs) to extend the network coverage and/or enhance the system throughput.

The traffic sent from the RS may be scheduled by itself or scheduled by the BS instead. With the first mechanism, the BS and RS perform scheduling independently. RS decodes the frame sent from the BS or MS/SS and processes it and then retransmits it in another frame to the MS/SS or BS in a different time slot. With the second mechanism, BS performs scheduling on behalf of RS. That is the BS reserves the bandwidth for RS to send the data and instructs the RS when and how to send the data.

For both mesh and relay modes, if the independent scheduling mechanism is used and the existing scheduling schemes are applied over the mesh or relay link, a synchronization issue is observed as described further below. The present invention provides a new mechanism to solve this problem.

This problem has been identified in a related application: U.S. Provisional Application 60/777,655 filed on Feb. 27, 2006 which is hereby incorporated in its entirety by reference. However, the scheme in Application 60/777,655 leads to waste of bandwidth grants in the first couple of frames in order to synchronize among multiple hops. Furthermore, if the buffering time in the intermediate nodes are too long, the user traffic may need to be dropped since the end-to-end delay already exceeds the limit. This may be acceptable for VoIP application but not for video application. The alternative scheme of the present invention does not lead to wasted bandwidth and potential packet drop and is suitable for all types of realtime applications. Application 60/777,655 is also more suitable for mesh networks, while the scheme of the present invention is more applicable to relay networks such as IEEE 802.16 MMR.

### DISCLOSURE OF THE INVENTION

A central idea of the invention is to use a resource allocation management message (e.g., 802.16 UL-MAP) in order to specify the time period in which each resource allocated in this resource allocation management message can be actually used by the specified user. Such a time period is for each resource allocated in the resource allocation management message, and could be different for different resources. Note that the present invention can be applied to multi-hop scenarios including mesh and/or relay in various wireless technologies, although the relay case over WiMax is used as an example, below.

In order to synchronize bandwidth grants and/or polls for uplink traffic over multiple hops, the uplink time interval pertaining to the information in each resource allocation frame should vary for each relay station (RS) on the path, and should be specified in the resource allocation frame (e.g. the UL-MAP). An advantage of the present invention is that no delay is generated due to scheduling non-synchronization between multiple hops on the path. No waste of bandwidth or potential packet drop is introduced. Another advantage is that the invention can be used to introduce relays in a network without modification to legacy end terminals.

### BRIEF DESCRIPTION OF THE DRAWINGS

FIG. 1 shows an example of a use Scenario of a relay station.

FIG. 2 shows a multi-hop environment.

FIG. 3 illustrates an example of non-synchronized scheduling for traffic.

FIG. 4 illustrates an example of non-synchronized scheduling for a transmission opportunity request.

FIG. 5 shows a generalized multi-hop network.

FIG. 6 is a flow chart showing a method according to an embodiment of the present invention.

FIG. 7 is a block diagram showing a system according to an embodiment of the present invention.

### DETAILED DESCRIPTION OF THE INVENTION

An embodiment of the present invention will now be detailed with the aid of the accompanying figures, building upon the existing technology. It is to be understood that this embodiment is merely an illustration of one particular implementation of the invention, without in any way foreclosing other embodiments and implementations.

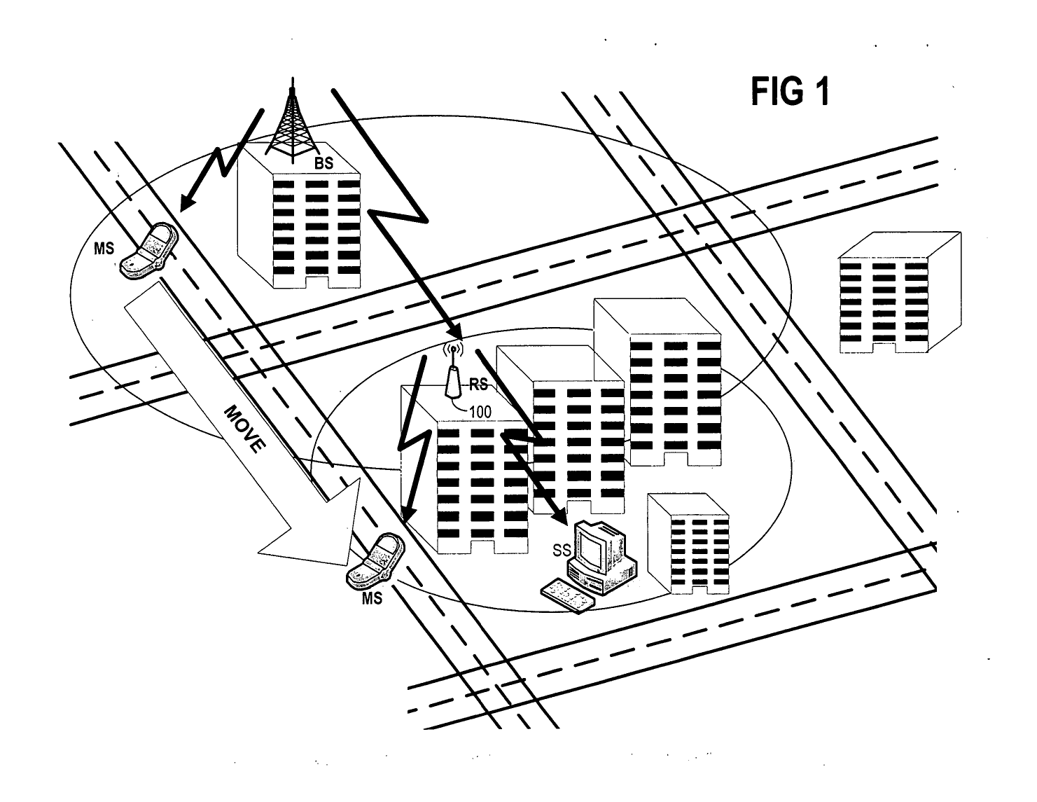

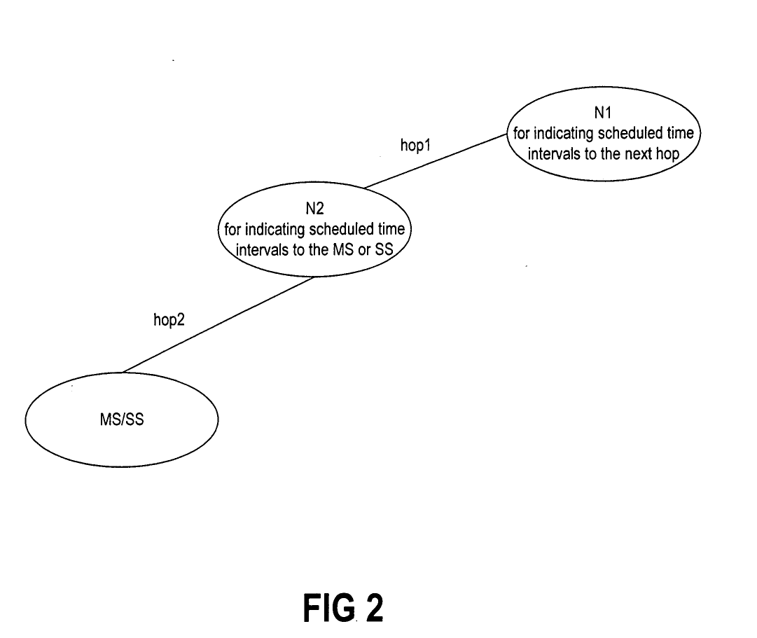

An exemplary usage scenario of a Relay Station 100 is shown in FIG. 1, for indicating scheduled time intervals to neighbors that are directly downlink. A simple multi-hop environment is illustrated in FIG. 2. MS/SS, Node 1 (N1) and Node 2 (N2) are connected to each other using wireless technology such as WiMax or WLAN. MS/SS acts as the source/destination of the user traffic. In the mesh case, N2 is the intermediate node on the path between the source and destination, while N1 could be the intermediate node or the correspondent node for the MS/SS (i.e., the source/destination of the user traffic). In the relay case, N2 is one RS on the path between MS/SS and BS, and N1 could be another RS on the path or the BS.

N1 is expected to offer a bandwidth grant to N2 and N2 is expected to offer a bandwidth grant to MS/SS. However, if the grants between N1 and N2 are not synchronized, then it may happen that when the grant to N2 is issued by N1, no data is ready in N2 since the grant to the MS/SS from N2 is not offered. For example, in IEEE 802.16 technology, the resource allocation information in the UL-MAP pertains to a frame in a fixed time interval; therefore, when multi hops are introduced, when the uplink traffic reaches N2 using the grant from N2, the grant to the N2 from N1 may already have expired. The traffic needs to be buffered and a new bandwidth request needs to be issued from N2 to N1, which leads to extra delay. Such delay increases as the number of intermediate RS increases. This is unacceptable especially for realtime traffic, and therefore the present invention includes configuring N2 to indicate a scheduled time interval to a downstream neighbor.

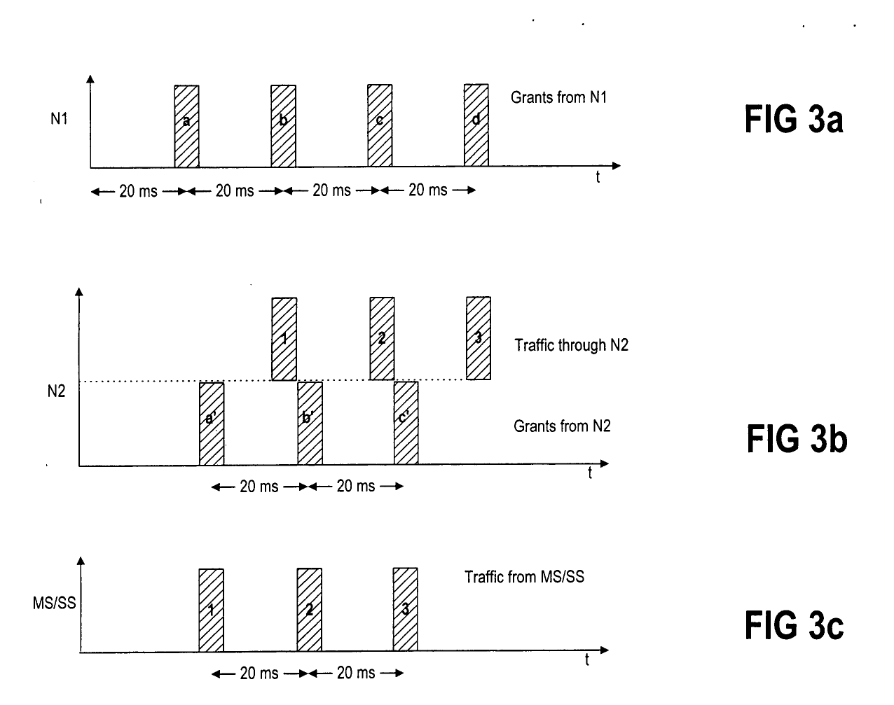

Assuming that periodical scheduling of user traffic is used, N1 is expected to offer a fixed size grant to N2 periodically and N2 is expected to offer a fixed size grant to MS/SS periodically. However, if the grants between N1 and N2 are not synchronized, then it may happen that when the grant to N2 is issued by N1, no data is ready in N2 since the grant to the MS/SS from N2 is not offered. FIG. 3 shows the details using VoIP as an example; i.e. FIG. 3 shows an example of non-synchronized Scheduling for Traffic. Assuming the grants provided by N1 triggers the grants from N2, and thus the grants from N2 follows the grants from N1. However, as shown in FIG. 3, when grant a from N1 is issued, N2 does not have any VoIP frame from the MS/SS to transfer. Followed by grant a, N2 immediately offers grant a′ to the MS/SS by sending resource allocation message. The VoIP frame 1 is sent from the MS/SS to N2 in the same frame. Since grant a from N1 already expired when VoIP frame 1 is received by N2, N2 needs to store it and wait for the next grant from N1. When grant b is issued from N1 after 20 ms, VoIP frame 1 is sent using that grant. It can be observed that the delay could be close to 20 ms contributed by each node on the path. If multiple nodes (e.g., multiple mesh nodes or relay stations) exist between the MS/SS and its correspondent node, the delay due to scheduling non-synchronization between the nodes in between could be close to n×20 ms. This is not acceptable, especially for realtime traffic.

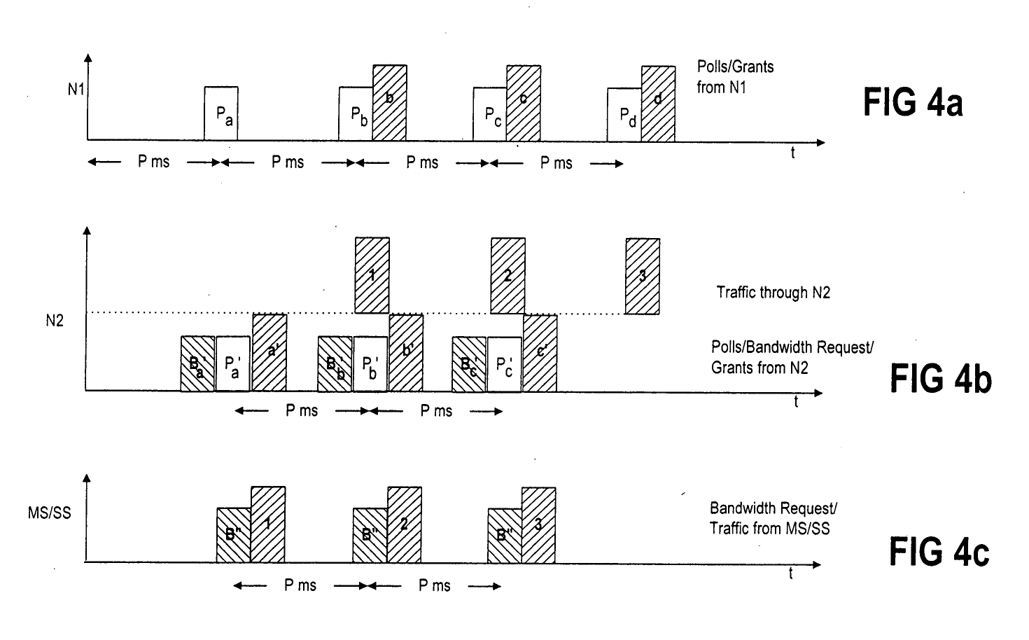

The similar problem applies to scheduling of transmission opportunity request (also termed as poll) as well. FIG. 4 shows an example of non-synchronized scheduling of transmission opportunity request. As shown in FIG. 4, assuming N1 provides N2 the opportunity to request for transmission by polling. When the first polling (Pₐ) is issued, N2 doesn't have any traffic to send. Therefore, N2 requests for 0 bandwidth in the Bandwidth Request (Bₐ′=0). Followed by polling Pₐ, N2 immediately sends a polling Pₐ′ to the MS/SS. The requested bandwidth is sent from the MS/SS to N2. N2 then provides a grant (grant a′) based on the requested bandwidth, which is used by the MS/SS to send data frame 1. However, since no grant is issued by N1, N2 doesn't have the resource to transmit the data frame 1 to N1. After P ms, another polling request (P_{b}) is issued from N1 to N2. N2 has data frame 1 in the buffer, and therefore request for bandwidth in B_{b}′. N1 then provides grant b, which is used by N2 to transmit data frame 1. It can be observed that the delay could be close to 20 ms contributed by one node on the path. If multiple nodes (e.g., mesh nodes or relay stations) exist between the MS/SS and its correspondent node, the delay due to scheduling non-synchronization between the nodes in between could be close to n×20 ms.

Periodical scheduling of the user traffic or transmission opportunity request are used as examples to describe the issue. The same problem applies to non-periodical scheduling of user traffic or transmission opportunity request without further illustration in this document.

In order to synchronize bandwidth grants and/or polls for uplink traffic over multiple hops, the uplink time interval pertaining to the information in each resource allocation frame should vary for each relay station (RS) on the path, and should be specified in the resource allocation frame (e.g. the UL-MAP). Such scheme can directly apply to 802.16 MMR technology.

For example, the resource allocated in the bandwidth grant or poll at current frame at node Ni−1 pertains to a frame to be transmitted in Ti−1, while the resource allocated in the bandwidth grant or poll at current frame at node Ni pertains to a frame to be transmitted in Ti. The time interval in which the information in the UL-MAP pertains to a frame for Ni−1 should be longer than that for Ni (i.e., Ti−1>Ti).

If distributed scheduling is used, each node Ni determines the time interval for each grant or poll it issues. This requires all the nodes (Ni) on the relay path to know the complete relay path so that each Ni can calculate the time interval for each bandwidth grant or poll it issues to ensure the synchronization of bandwidth grant or poll over multiple hops on the relay path. In the relay system, either centralized scheduling (i.e., scheduling being done by the BS for each RS on the relay path) or distributed scheduling is used (i.e., scheduling being done by each RS itself on the relay path). In the case of centralized scheduling, the BS determines the time interval for each grant or poll issued on each RS on the path and specifies that in the resource allocation frame (e.g., IEEE 802.16 UL-MAP).

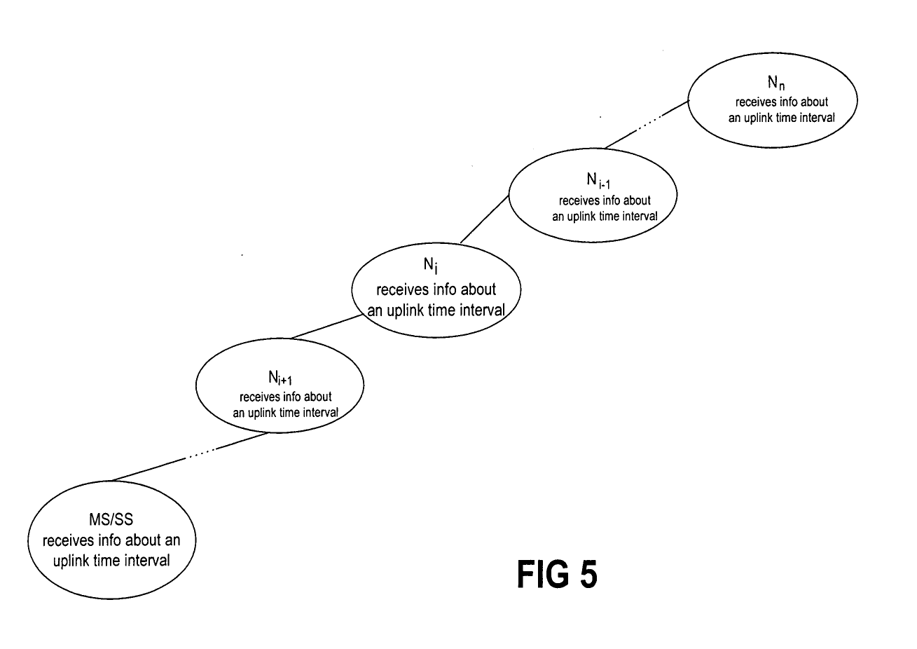

The resource allocation frame (e.g., IEEE 802.16 UL-MAP) is enhanced to specify such time interval for each uplink grant or poll. However, this only applies to the bandwidth grant or poll issued from Ni to its direct downlink neighbor RS Ni+1. No change is required to UL-MAP to MS/SS. Accordingly, FIG. 5 shows a Generalized Multi-Hop Network.

In order to solve the scheduling synchronization problem in a multi-hop environment as described above, this invention proposes a simple and efficient synchronization approach. If applied to the WiMax technology, such solution only requires modification to resource allocation messages (such as the UL-MAP or MAC management message) to the RSs, not the legacy MS/SS. The present invention includes a basic method wherein a time period is determined during which each resource allocated in a resource allocation management message is available for a specified user. Then, the resource allocation management message is used to provide said time period. The resource allocation management message can be, as mentioned, an 802.16 uplink bandwidth allocation map (UL-MAP) or MAC management message. Such a MAP message carries schedule information (i.e. a map).

The present invention also includes a computer readable medium encoded with a software data structure for performing the basic method just described. Also, the present invention includes a software product comprising a computer readable medium having executable codes embedded therein; the codes, when executed, adapted to determine a time period during which each resource allocated in a resource allocation management message is available for a specified user, and then provide said time period within said resource allocation management message.

The present invention further includes an apparatus having a processor configured to determine a time period during which each resource allocated in a resource allocation management message is available for a specified user. The apparatus further comprises a transmission module configured to provide said time period within the resource allocation management message.

The present invention additionally includes an apparatus for determining a time period during which each resource allocated in a resource allocation management message is available for a specified user. The apparatus further provides said time period within the resource allocation management message.

And, the present invention additionally includes a system having a processor configured to determine a time period during which each resource allocated in a resource allocation management message is available for a specified user. The system further comprises a transmission module configured to provide said time period within the resource allocation management message.

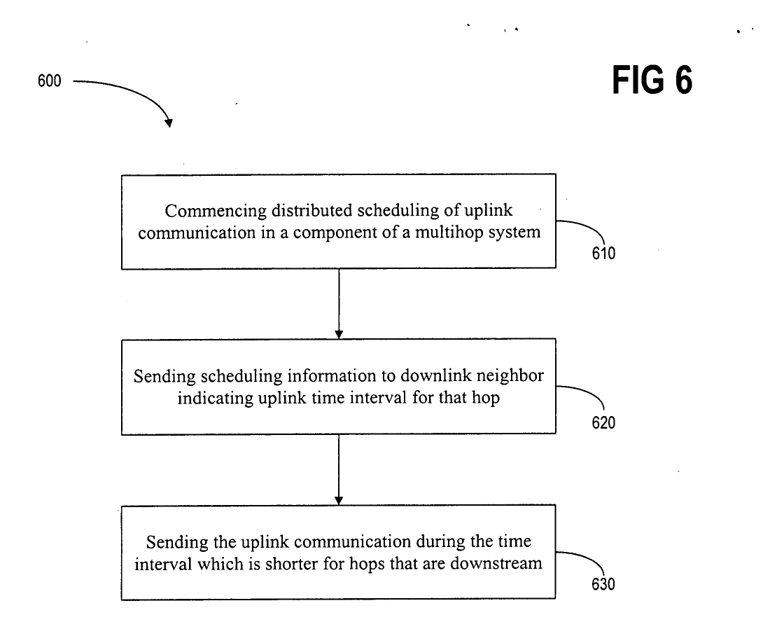

Additionally, as shown in FIG. 6, an embodiment of the invention is a method 600 in which distributed scheduling is commenced 610, in multihop system. Subsequently, scheduling information is sent 620 to a downlink neighbor, indicating an uplink time interval for that hop. And finally, uplink communication is sent 630 during those time intervals which are shorter for hops that are downstream (as opposed to upstream).

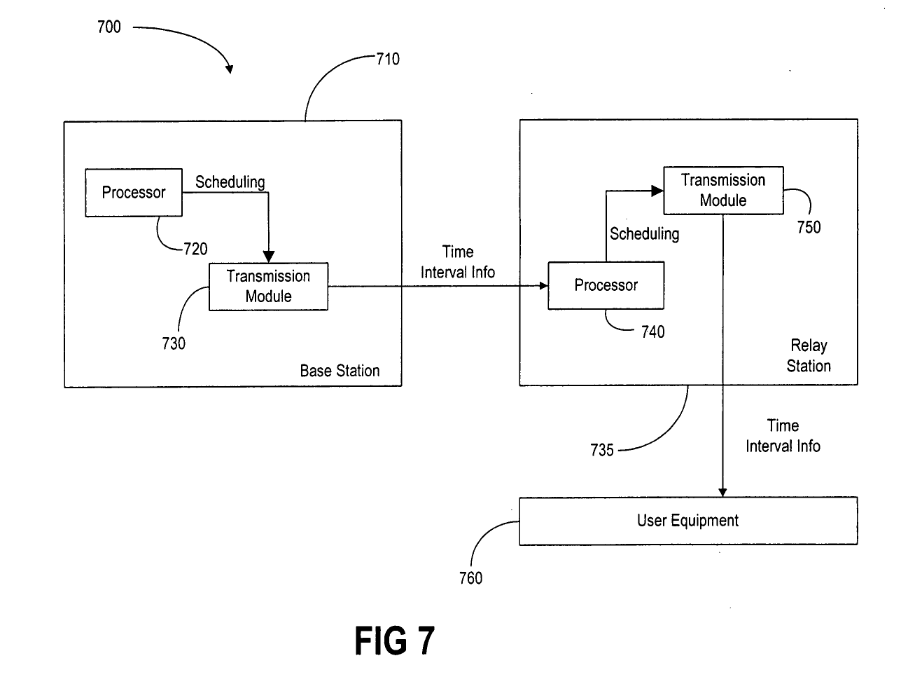

FIG. 7 is a block diagram showing a system 700 according to an embodiment of the present invention, including a base station 710, a relay station 735 that is a downstream hop from the base station, and a user equipment 760 that is two hops downstream from the base station 710. The base station 710 includes a processor 720 that commences the base station's scheduling of upstream communication, for the uplink hop from the relay station to the base station. A transmission module 730 then sends information about a scheduled time interval to the relay station. The relay station 735 is similarly configured, including a processor 740 and a transmission module 750. The user equipment 760 will then be able to send uplink communication (e.g. data traffic or request for bandwidth) during the time intervals, which are progressively longer for hops in the upstream direction.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method comprising:
commencing distributed scheduling of uplink communication in a component of a multihop system; and
sending information that is related to said scheduling to a direct downlink neighbor along a path, said information at least indicating a time interval available for said uplink communication, said time interval corresponding to the hop between said neighbor and said component along said path.

2. The method of claim 1, wherein said time interval is shorter for a hop that is downstream from another hop which corresponds to a longer time interval.

3. The method of claim 1, wherein said multihop system is a relay system, and wherein said component is a base station or a relay station.

4. The method of claim 1, wherein said sending information to the direct downlink neighbor is in response to a bandwidth request from said downlink neighbor requesting said bandwidth in said time interval, and wherein said uplink communication uses said bandwidth during said time interval.

5. The method of claim 1, wherein said uplink communication comprises uplink user traffic, or comprises at least one request for bandwidth to send said uplink user traffic, or comprises both.

6. The method of claim 5, wherein said at least one request for bandwidth to send said uplink user traffic is in response to a poll sent from an upstream location.

7. The method of claim 1, further comprising sending said uplink communication along each hop of the path, before each respective time interval has expired.

8. The method of claim 1, wherein said distributed scheduling is periodical.

9. The method of claim 1, wherein said information related to said scheduling is included in a resource allocation management message.

10. An apparatus comprising:
means for commencing distributed scheduling of uplink communication in a component of a multihop system; and
means for sending information that is related to said scheduling to a direct downlink neighbor along a path, said information at least indicating a time interval available for said uplink communication, said time interval corresponding to the hop between said neighbor and said component along said path.

11. The apparatus of claim 10, wherein said time interval is shorter for a hop that is downstream from another hop which corresponds to a longer time interval.

12. The apparatus of claim 10, wherein said multihop system is a relay system, and wherein said component is a base station or a relay station.

13. The apparatus of claim 10, wherein said apparatus is responsive to a bandwidth request from said downlink neighbor requesting said bandwidth in said time interval, and wherein said uplink communication uses said bandwidth during said time interval.

14. The apparatus of claim 10, wherein said uplink comprises uplink user traffic, or comprises at least one request for bandwidth to send said uplink user traffic, or comprises both.

15. The apparatus of claim 14, wherein said at least one request for bandwidth to send said uplink user traffic is in response to a poll sent from an upstream location along the path.

16. The apparatus of claim 10, further comprising means for sending said uplink communication along each hop of the path, before each respective time interval has expired.

17. The apparatus of claim 10, wherein said distributed scheduling is periodical.

18. The apparatus of claim 10, wherein said information related to said scheduling is included in a resource allocation management message.

19. An apparatus comprising:
a processor configured to commence distributed scheduling of uplink communication in a component of a multihop system; and
a transmission module configured to send information that is related to said scheduling to a direct downlink neighbor along a path, said information at least indicating a time interval available for said uplink communication, said time interval corresponding to the hop between said neighbor and said component along said path.

20. The apparatus of claim 19, wherein said time interval is shorter for a hop that is downstream from another hop which corresponds to a longer time interval.

21. The apparatus of claim 19, wherein said multihop system is a relay system, and wherein said component is a base station or a relay station.

22. The apparatus of claim 19, wherein said apparatus is responsive to a bandwidth request from said downlink neighbor requesting said bandwidth in said time interval, and wherein said uplink communication uses said bandwidth during said time interval.

23. The apparatus of claim 19, wherein said uplink comprises uplink user traffic, or comprises at least one request for bandwidth to send said uplink user traffic, or comprises both.

24. The apparatus of claim 23, wherein said at least one request for bandwidth to send said uplink user traffic is in response to a poll sent from an upstream location along the path.

25. The apparatus of claim 19, further comprising means for sending said uplink communication along each hop of the path, before each respective time interval has expired.

26. The apparatus of claim 19, wherein said distributed scheduling is periodical.

27. The apparatus of claim 19, wherein said information related to said scheduling is included in a resource allocation management message.

28. A computer readable medium encoded with a software data structure for:
commencing distributed scheduling of uplink communication in a component of a multihop system; and
sending information that is related to said scheduling to a direct downlink neighbor along a path, said information at least indicating a time interval available for said uplink communication, said time interval corresponding to the hop between said neighbor and said component along said path.

29. The computer readable medium of claim 28, wherein said time interval is shorter for a hop that is downstream from another hop which corresponds to a longer time interval.

30. The computer readable medium of claim 28, wherein said multihop system is a relay system, and wherein said component is a base station or a relay station.

31. The computer readable medium of claim 28, wherein said sending information to the direct downlink neighbor is in response to a bandwidth request from said downlink neighbor requesting said bandwidth in said time interval, and wherein said uplink communication uses said bandwidth during said time interval.

32. The computer readable medium of claim 28, wherein said uplink communication comprises uplink user traffic, or comprises at least one request for bandwidth to send said uplink user traffic, or comprises both.

33. The computer readable medium of claim 32, wherein said at least one request for bandwidth to send said uplink user traffic is in response to a poll sent from an upstream location.

34. The computer readable medium of claim 28, wherein the software data structure is also for sending said uplink communication along each hop of the path, before each respective time interval has expired.

35. The computer readable medium of claim 28, wherein said distributed scheduling is periodical.

36. The computer readable medium of claim 28, wherein said information related to said scheduling is included in a resource allocation management message.

37. A multihop system comprising:
a base station configured to commence distributed scheduling of uplink communication; and
a relay station configured to receive information that is related to said scheduling, from the base station,
wherein the relay station is a direct downlink neighbor of the base station along a path,
wherein said information at least indicates a time interval available for said uplink communication, said time interval corresponding to the hop between said relay station and said base station.

38. The system of claim 37, wherein said time interval is shorter for a hop that is downstream from another hop which corresponds to a longer time interval.

39. The system of claim 37, wherein said commencing distributed scheduling is in response to a bandwidth request from said relay station requesting said bandwidth in said time interval, and and wherein said uplink communication uses said bandwidth during said time interval.

40. The system of claim 37, wherein said uplink communication comprises uplink user traffic, or comprises at least one request for bandwidth to send said uplink user traffic, or comprises both.

41. The system of claim 37, wherein said at least one request for bandwidth to send said uplink user traffic is in response to a poll sent from an upstream location.

42. The system of claim 37, further comprising means for sending said uplink communication along each hop of the path, before each respective time interval has expired.

43. The system of claim 37, wherein said distributed scheduling is periodical.

44. The system of claim 37, wherein said information related to said scheduling is included in a resource allocation management message.
